(19) United States
(12) Patent Application Publication
(10) Pub. No.: US 2010/0106795 A1
(43) Pub. Date: Apr. 29, 2010

(54) VARIABLE SIZE MESSAGE INDICATOR IN COMMUNICATION DEVICE

(75) Inventors: WILLIAM P. ALBERTH, JR., PRAIRIE GROVE, IL (US); THEODORE R. ARNESON, IVANHOE, IL (US); WILLIAM S. HEDE, LAKE IN THE HILLS, IL (US)

Correspondence Address: MOTOROLA INC, 600 NORTH US HIGHWAY 45, W4 - 39Q, LIBERTYVILLE, IL, 60048-5343, US

(73) Assignee: MOTOROL, INC., LIBERTYVILLE, IL (US)

(21) Appl. No.: 12/260,500

(22) Filed: Oct. 29, 2008

(51) Int. Cl. G06F 15/16

(52) U.S. Cl. 709/207

(57) ABSTRACT

A communication device having a display interface coupled to a controller configured to determine a status of messages received, to present a list of message indicators on the display interface, and to indicate the status of each message by presenting a corresponding message indicator with a textual character having a size that is based on the status of the corresponding message. The message status may be, among other characteristics, the priority or age of the message as determined by the controller.

### FIELD OF THE DISCLOSURE

The present disclosure relates generally to communication devices, and more particularly to displaying a list of message indicators, for example, in email or messaging applications run on wireless communication handsets and on other communication devices.

### BACKGROUND

Communication devices including computers and cellular telephones that run messaging applications often receive large numbers of messages. Messaging applications include email applications like Microsoft Outlook and Mozilla Thunderbird implemented on personal computers and on some smart phones. Other messaging applications include text messaging applications like Short Messaging Service (SMS) and Enhanced Messaging Service (EMS) applications run on mobile telephone devices and Multimedia Messaging Service (MMS) run on some smart phones. Other messaging applications including chat and Instant Messaging (IM) applications, for example, AOL Instant Messenger, are real-time applications that run on various communication devices. Mobile Instant Messaging (MIM) applications are presence enabled messaging services designed to run on mobile devices.

It is known generally to indicate the priority or some other aspect of incoming calls and messages based on an evaluation of the call or message. For example, some e-mail applications indicate “high priority” messages in the in-box with asterisk next to a message indicator or with a color coded message indicator. It is also known to indicate the priority of incoming calls or messages with an audio alert.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is a communication device.

FIG. 2 is a process flow diagram.

### DETAILED DESCRIPTION

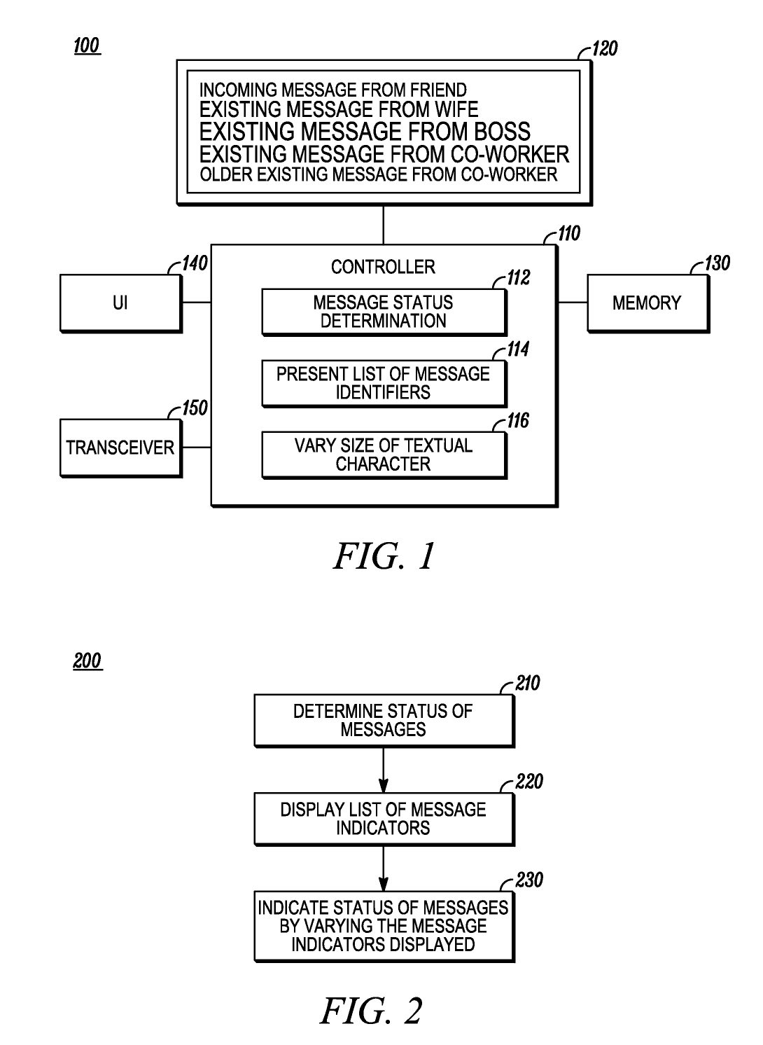

FIG. 1 illustrates a communication device 100 that implements a messaging application. The messaging application is generally capable of enabling the communication of messages and displaying a list of messages received or transmitted as discussed more fully below. Exemplary messaging applications include among others email applications, text messaging applications, chat and other Instant Messaging (IM) applications, and Mobile Instant Messaging (MIM) applications, specific examples of which are discussed above. The instant disclosure applicable more generally to any messaging application in which a list of message indicators is displayed on a user interface of the communication device as discussed further below. The messaging application may also be of the sort that includes a list of message indicators corresponding to non-text messages, for example, voice messages. The messaging application is typically a software application run on an operating system like Microsoft Windows or Android or some other operating system, but it may also be implemented without an operating system.

Generally, the message indicators, that constitute the list, each include one or more textual characters. The textual characters typically comprise alphanumeric characters, including numbers and alphabetical characters of any language and symbols. In some email applications, the textual characters displayed on the list are selected or configured by the user. Such characters may be in the form of the name of the message originator, message subject, received message date, etc. Nevertheless, in the messaging applications contemplated by some embodiments of the instant disclosure, each message indicator includes one or more textual characters associated with the corresponding message.

In the exemplary embodiment, the communication device is a handheld wireless communication device, for example a cellular telephone or a smart phone or a dedicated messaging device, or some other device that displays messages. The communication device may also be implemented as a personal or laptop computer with a wireless connection over which messages are communicated. In other embodiments, the communication device is a wire-line communication device, for example a personal or laptop computer coupled to a wire-line, in which messages are communicated.

The communication device 100 comprises generally a controller 110 communicably coupled to a display interface 120. The display interface may be integrated within a unitary housing of the communication device or it may be a discrete device coupled to a motherboard in a separate housing. The controller is also coupled to memory 130, which may be embodied as RAM or ROM or other known memory devices. The controller is typically embodied as a digital processor that executes binary instructions stored in memory. These instructions enable the performance of various functions and operations. For example, messaging application code stored in memory is executed by the controller to perform functions associated with the messaging application. Code for performing other functions, features, and aspects of the instant disclosure may also be stored in memory for execution by the controller as discussed more fully below. While the exemplary controller is illustrated as a single element, more generally, it may be implemented as multiple controllers or processors. For example, the display interface may be controlled by a dedicated video processor that interfaces with a system processor. Alternatively, the controller may be implemented as an equivalent hardware device or as a combination of hardware and software controlled devices. The device also typically includes other user interface elements, which are shown schematically as 140. These user interface elements may, but do not necessarily, include keypads, audio input/outputs among other user interface elements.

In FIG. 1, the device 100 also includes a transceiver 150 capable of transmitting and receiving messages. The transceiver may be a wireless or wire-line type transceiver. For example, the communication device may include one or more wireless transceivers such as a cellular transceiver and a wireless WLAN transceiver. Some devices may also include a wire-line transceiver. In one embodiment, the communication device includes only a receiver and is incapable of transmitting messages. In other embodiments the communication device includes only a transmitter and is incapable of receiving messages. More generally, however, the communication device is capable of both sending and receiving messages.

According to one aspect of the disclosure, the controller is configured to determine a status of messages on the communication device. In FIG. 1, at 112, the controller includes message status determination functionality. In the process 200 diagram of FIG. 2, at 210, the status of at least some of the messages received is determined by the controller. In the exemplary embodiment this functionality is enabled when the controller executes software stored in memory. The specific event that precipitates the determination of the message status depends generally on what status is being determined. In some embodiments the message status is set explicitly, for example, by the sender. The message may also be encoded to indicate its status. In other embodiments the message status is implied, for example, based upon one or more criterion established by the recipient. In some embodiments the message status may be determined as a matter of degree. For example the message status may assume any one of a number of possible states or degrees. Some non-limiting examples of possible message statuses are discussed below.

In one embodiment the status of the message is its priority. The message priority may be set by the originator or by the recipient. Where and when the priority of the message is set is immaterial. The priority could be set by the sender at the time of transmission or it could be set at the time of receipt by the receiving device or some time thereafter. In some embodiments the message priority may assume any one of multiple levels, for example high medium or low priority. The message priority may be indicated to the controller using a flag associated with the message or by some other mechanism. In one embodiment, for example a bit in the message header or other part thereof is set to indicate the priority. Alternatively the priority status of the message may be communicated in a separate message associated with the message to which the status relates. How the message priority is indicated to the controller is immaterial as long as the controller is capable of determining the message priority. According to this embodiment the controller determines the message priority by evaluating a priority indicator that is a part of or is otherwise associated with the message.

In another embodiment the status of the message is a measure of the age of the message. The measure of the age of the message is a measure of time that has lapsed since the message was transmitted or since the message was received or some time thereafter. More generally the age of the message may be measured relative to any reference time or event. For example the occurrence of an event may precipitate the determination of the elapsed time. Such an event may be the deletion of the message wherein the message indicator is stored in a recycle bin. In other embodiments other events may form the basis for determining the age of the message.

In another embodiment the status is based on the sender of the message. In one embodiment, for example the status of the message originator is specified by a predefined hierarchy that ranks the origin or class of origins the messages that may be received by the device. According to this example the status of the originator, and hence the message, depends upon originator's rank within the hierarchy. Alternatively the message originator may be classified in groups such as: friend, co-worker, family, spouse, supervisor, etc. An exemplary hierarchy based on originator classification, ranked from lowest to highest is as follows: friend; co-worker; spouse; and supervisor. In one implementation the controller determines the status upon receipt of the message, although in other embodiments the status of the message may be determined some time after the message is received.

In another embodiment, the priority of the message may be based on location generally. In a more particular implementation, the status is based on a location of the communication device when the message was received. In another embodiment, the message status is determined based on the location of the originator of the message. Controller 110 may also include means to determine location such as a Global Positioning System (GPS) receiver, as is well known in the industry. A message may include information about the location of the sender. If the location meets a criteria (for instance if the sender was at a hospital) then the priority of the message would be increased. The location criteria may be a specific location, a type of business, or more complex logical expressions that include location. It is known to monitor location of family members especially children and to monitor if they are in specific locations at predetermined times, such as at school during school hours. If the sender is not within predetermined time and space locations, then the priority of the message would be increased.

If the user is in a specific location, then the priority may also be increased. For example the user may predetermine that messages received while he is in a bar should be increased in priority. When a message is received, the location of the user is compared to rules at least partially determined by the user and if the condition is met, the priority of the message is increased.

In FIG. 1, at 114, the controller is configured to present a list of message indicators on the display interface wherein each message indicator is associated with a corresponding message. In FIG. 2, at 220, a list of message indicators is presented on a display interface of the device for user consumption. In the exemplary embodiment this functionality is enabled when the controller executes software stored in memory. The specific event that precipitates the determination of the message status depends generally on how the messaging application is configured. The list of message indicators is typically displayed when the user opens a message box associated with the messaging application. Exemplary message boxes include but are not limited to: in-box, out-box, sent-box, deleted-box, saved-box, draft-box, etc. Alternatively the message indicator list may be displayed upon the occurrence of some other event. The particular form of the presentation of the list of message indicators and the particular mechanism that prompts the presentation of the list is immaterial, as the teachings of the disclosure apply to all message indicator lists regardless the mechanism by which the list is presented on the display device.

In one embodiment, generally a characteristic of the message indicator corresponding to the message is modified or varied based on the status of the message. In FIG. 2, the status of the messages for which the message status was determined is indicated by presenting the corresponding message indicator with a textual character having a size that is based on the status of the corresponding message. Examples of message status determined by the controller are discussed above. In one implementation, the characteristic of the message indicator is a visual characteristic that communicates the message status to a user of the communications device when the message indicator is displayed on the display interface of the device. Alternatively an audio characteristic of the message indicator is communicated to the user via an audio interface of the communication device.

In embodiments where each message indicator includes one or more textual characters associated with the corresponding message, the controller configured to indicate the status of each message, to the user, by presenting the corresponding message indicator with a textual character having a size that is based on the status of the corresponding message. In FIG. 1, at 116, the controller includes functionality that varies the size of the textual character based on the status of the message as determined by controller. In the exemplary embodiment, this functionality is enabled when the controller executes software stored in memory.

In one embodiment the controller varies the font point size of the textual character based on the status of the message and the controller presents each message indicator with a textual character having a font point size that depends on the status of the corresponding message. In related embodiments the height and width of the message are varied disproportionately depending on the status of the corresponding message. For example, the width or the height of the textual characters may be varied independently. In FIG. 1 the size of the textual character is based on the status of the message originator. Particularly the message from the recipient's “boss” has the largest font size, the message from the recipient's “wife” has the next largest font size, the message from the recipient's “co-worker” has the next largest font size, and the message from the recipient's friend has the smallest font size.

In embodiments where the status of the message corresponds to its age, the textual character of the message indicator has a size that depends on the age of the corresponding message. For example the messages indicator for newer messages may be presented or displayed with a larger font size and the message indicators for older messages displayed with a smaller font size. FIG. 1 illustrates an older message wherein the textual character of the corresponding message indicator has a relatively small size. Alternatively, the message indicator for older messages may be displayed with a larger font size to facilitate identification of the older messages by the user. In one embodiment the user may specify the relationship between the font size and the status. Thus the user could select whether the message indicator for older messages or for newer messages are displayed with larger fonts sizes.

In embodiments where the status of the message corresponds to message priority, the textual character of the message indicator has a size that depends on the priority of the corresponding message. For example the messages indicator for higher priority messages may be presented or displayed with a larger font size and the message indicators for lower priority messages may be displayed with a smaller font size.

The size of the textual character may be varied based on the message status without affecting other characteristics of the list. For example, the list of message indicators may be ordered based on one or more criterion other than the status of the messages. More particularly the ordering may be based on the time or date of receipt of the message and the font point size may be based on the age of the message or on the classification of the originator of the message.

While the present disclosure and the best modes thereof have been described in a manner establishing possession by the inventors and enabling those of ordinary skill to make and use the same, it will be understood that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A communication device comprising:
a display interface;
a controller communicably coupled to the display interface,
the controller configured to determine a status of messages,
the controller configured to present a list of message indicators on the display interface, each message indicator associated with a corresponding message, and each message indicator includes at least one textual character, and
the controller configured to indicate the status of each message by presenting the corresponding message indicator with a textual character having a size that is based on the status of the corresponding message as determined by the controller.

2. The device of claim 1, the size of the textual character is a font point size, the controller configured to present each message indicator with a textual character having a font point size that depends on the status of the corresponding message.

3. The device of claim 1, the controller configured to indicate the status of each message received by presenting the message indicator of each message with a textual character having a height and width with different dependence on the status of the corresponding message.

4. The device of claim 1, the status of each message is a measure of an age of the message.

5. The device of claim 4,
the size of the textual character is a font point size,
the controller configured to present each message indicator with a textual character having a font point size that depends on the age of the corresponding message,
at least some textual characters of the message indicators have different font point sizes.

6. The device of claim 1, the status of each message is a measure of a priority level of the message.

7. The device of claim 6,
the size of the textual character is a font point size,
the controller configured to present each message indicator with a textual character having a font point size that depends on the priority level of the corresponding message,
at least some textual characters of the message indicators have different font point sizes.

8. The device of claim 1, the status of each message corresponds to an originator of the message.

9. The device of claim 8,
the size of the textual character is a font point size,
the controller configured to present each message indicator with a textual character having a font point size that depends on the originator of the corresponding message,
at least some textual characters of the message indicators have different font point sizes.

10. The device of claim 1, further comprising ordering the message indicators in the list presented on the display interface based on a criterion other than the status of the messages.

11. The device of claim 1 further comprising a receiver coupled to the controller, the controller configured to determine the status of messages received by the receiver.

12. The device of claim 1 is a handheld wireless communication device.

13. A method in a communications device, the method comprising:
receiving multiple messages;
determining a status of at least some of the messages received;
presenting a list of message indicators on a display interface of the device, each message indicator associated with a corresponding message, and each message indicator includes at least one textual character, and
indicating the status of the messages for which the status was determined by presenting the corresponding message indicator with a textual character having a size that is based on the status of the corresponding message as determined by the controller.

14. The method of claim 13, determining the status the messages by determining an age of the message.

15. The method of claim 14,
the size of the textual character is a font point size,
presenting each message indicator with a textual character having a font point size that depends on the age of the corresponding message.

16. The method of claim 13, determining the status of the messages by determining a priority level of the message.

17. The method of claim 16,
the size of the textual character is a font point size,
presenting each message indicator with a textual character having a font point size that depends on the priority level of the corresponding message.

18. The method of claim 13, determining the status of the messages by determining an originator of the message.

19. The method of claim 18,
the size of the textual character is a font point size,
presenting each message indicator with a textual character having a font point size that depends on the originator of the corresponding message.

20. The method of claim 13,
the controller is configured to obtain location information about from where messages were sent,
the status of the message is dependent on the location information.
